(19) United States
(12) Patent Application Publication
(10) Pub. No.: US 2014/0058752 A1
(43) Pub. Date: Feb. 27, 2014

(54) COMPUTER NETWORK FOR QUALITY TESTING CLINICAL TRIAL DATA

(71) Applicant: SIEMENS AKTIENGESELLSCHAFT, Munich (DE)

(72) Inventors: Mario BECHTOLD, Hemhofen (DE); Andreas KELLER, Puettlingen (DE); Rainer KUTH, Hoechstadt (DE); Gerd SCHMIDT, Fuerth (DE); Cord Friedrich Stähler, Hirschberg an der Bergstrasse (DE)

(73) Assignee: SIEMENS AKTIENGESELLSCHAFT, Munich (DE)

(21) Appl. No.: 13/970,855

(22) Filed: Aug. 20, 2013

(30) Foreign Application Priority Data
Aug. 21, 2012 (DE) 102012214812.4

(51) Int. Cl. G06F 19/00

(52) U.S. Cl. CPC G06F 19/363
USPC 705/3

(57) ABSTRACT

A computer network system and a method for quality testing input clinical trial data are disclosed. The trial data is recorded by way of a form provided on a patient device or a physician device and is passed on in an encrypted, anonymized form to a central server. A quality testing device is installed on the server in order to test the recorded medical data sets with regard to the quality thereof. The scope of the quality test is configurable. In the event of successful testing, an incentive attribute is read out from a database in order to generate an incentive signal and to transmit the signal to the respective terminal device.

### PRIORITY STATEMENT

The present application hereby claims priority under 35 U.S.C. §119 to German patent application number DE 102012214812.4 filed Aug. 21, 2012, the entire contents of which are hereby incorporated herein by reference.

### FIELD

At least one embodiment of the invention generally belongs within the field of medical technology and network technology and at least one embodiment concerns, in particular, a computer network and a method for quality testing clinical trial data.

### BACKGROUND

Clinical trials and, in particular, pharmaceutical trials or trials of medical devices or biotechnology studies are very costly because acquisition of the medical data of relevance to the trial is sometimes very complex and time-consuming. In most countries furthermore, approval procedures are also necessary to be able to set up clinical trials at all.

Due to the cost pressure on health services, attempts are being made nowadays to test the quality and efficiency of clinical trials.

Within the context of evidence-based medicine, the success of medical measures, in particular clinical trials, is also to be made quantitatively measurable.

Practice shows that the acquisition of trial-relevant medical data sets is an important factor in assessing the reliability and the quality of clinical trials.

### SUMMARY

At least one embodiment of the present invention provides a way by which the disadvantages of methods of performing trials can be improved. Furthermore, the quality and efficiency of clinical trials may be made testable in at least one embodiment and the entities and/or persons involved are to be rewarded if they are able to maintain a high pre-configurable quality standard in recording the clinical trial data.

A system and a method are disclosed with which a qualitatively high value input of the trial-relevant medical data is rewarded. The reward may take the form of a financial advantage, a collection of points, access to trial data and/or other actions (e.g. the offering of further services, including in the medical field). Furthermore, other further-reaching measures for evaluating the medical data are also to be provided.

The quality relates to the input of the respective trial data. This quality is checked with pre-configurable quality tests. Preferably, a check is made for the completeness of the data entry, for consistency of the data input and/or for further circumstances (semantic and/or syntactic correctness).

According to one embodiment, the invention relates to a method for exchanging medical data sets for quality testing the data sets when clinical trials are being performed. The trial-relevant medical data sets are thereby input into a terminal device. The terminal device can be operated by a patient and/or by a medical service provider, for example, by a physician or a medical-technical assistant.

The method of at least one embodiment comprises:
Recording patient-specific, service provider-specific and/or terminal device-specific identification data, such as an identification code of a physician, for example. Preferably, the identification data is recorded here in relation to the trial participant (this may be the person himself or the device at which he is working).
Reading in trial-relevant medical data sets, wherein the medical data sets can be input by the patient and/or the service provider and/or an involved person—preferably in the context of a medical procedure—by way of a pre-configurable form.
Creating an encrypted data package which comprises the read-in medical (study-relevant) data sets and the recorded identification data (of the inputting person).
Sending the encrypted data package to a central server. This is preferably carried out via the internet. Alternatively, other networks (wide area network—WAN, or local area network—LAN, etc.) can also be used.
Receiving the encrypted data package on the central server and unpacking thereof.
Carrying out a pre-configurable quality test with the decrypted medical data.
In the event of a successful quality test:
Accessing a database to acquire an incentive attribute.
Sending an incentive signal with the incentive attribute as a response to the transmitted, encrypted data packet. The incentive signal is preferably sent at least to the respective service device. Optionally, it is possible also to transmit the incentive signal to other computer-based entities, e.g. to the computer which is configured to administer the study.

According to a further embodiment, the present invention relates to a computer network system for quality testing clinical trial data that is input into a terminal device of a trial participant (medical service provider and/or patient).

Apart from the terminal devices, the computer network system also comprises identification devices. Preferably an identification device is provided for each patient and for each medical service provider, if both the patient and the medical service provider participate in the clinical trial. However, it is equally possible for only the physician or only the patient to participate in the clinical trial. In this event, only the person involved must identify or authenticate him or herself to the system. The computer network system comprises an encryption unit in order to transmit the medical data sets to be transmitted from the respective terminal device in anonymized form to the central server. The transmission is preferably carried out via the internet.

A further solution to the problem resides in a computer program product according to the accompanying claims.

The inventive embodiments of the method as disclosed herein can also be configured as a computer program product with a computer program, the computer being caused to carry out at least one embodiment of the inventive method described above when the computer program is executed on the computer or on a processor of the computer.

An alternative solution to the problem lies in a computer program with computer program code for carrying out all the method steps of an embodiment of the method claimed or described above, when the computer program is executed on the computer. The computer program can also be stored on a machine-readable storage medium.

An alternative solution to the problem provides for a storage medium which is intended for storing an embodiment of the computer-implemented method described above and is readable by a computer.

### BRIEF DESCRIPTION OF THE DRAWINGS

Example embodiments, which should be understood as not being restrictive, will now be described together with the features and further advantages thereof, making reference to the drawings, in which:

FIG. 1 is a schematic overview of a computer network system according to an example embodiment of the present invention and

FIG. 2 is a representation of a sequence for a method for quality testing medical trial data according to an example embodiment of the invention.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the present invention provides a way by which the disadvantages of methods of performing trials can be improved. Furthermore, the quality and efficiency of clinical trials may be made testable in at least one embodiment and the entities and/or persons involved are to be rewarded if they are able to maintain a high pre-configurable quality standard in recording the clinical trial data.

A system and a method are disclosed with which a qualitatively high value input of the trial-relevant medical data is rewarded. The reward may take the form of a financial advantage, a collection of points, access to trial data and/or other actions (e.g. the offering of further services, including in the medical field). Furthermore, other further-reaching measures for evaluating the medical data are also to be provided.

The quality relates to the input of the respective trial data. This quality is checked with pre-configurable quality tests. Preferably, a check is made for the completeness of the data entry, for consistency of the data input and/or for further circumstances (semantic and/or syntactic correctness).

According to one embodiment, the invention relates to a method for exchanging medical data sets for quality testing the data sets when clinical trials are being performed. The trial-relevant medical data sets are thereby input into a terminal device. The terminal device can be operated by a patient and/or by a medical service provider, for example, by a physician or a medical-technical assistant.

The method of at least one embodiment comprises:
Recording patient-specific, service provider-specific and/or terminal device-specific identification data, such as an identification code of a physician, for example. Preferably, the identification data is recorded here in relation to the trial participant (this may be the person himself or the device at which he is working).
Reading in trial-relevant medical data sets, wherein the medical data sets can be input by the patient and/or the service provider and/or an involved person—preferably in the context of a medical procedure—by way of a pre-configurable form.
Creating an encrypted data package which comprises the read-in medical (study-relevant) data sets and the recorded identification data (of the inputting person).
Sending the encrypted data package to a central server. This is preferably carried out via the internet. Alternatively, other networks (wide area network—WAN, or local area network—LAN, etc.) can also be used.
Receiving the encrypted data package on the central server and unpacking thereof.
Carrying out a pre-configurable quality test with the decrypted medical data.
In the event of a successful quality test:
Accessing a database to acquire an incentive attribute.
Sending an incentive signal with the incentive attribute as a response to the transmitted, encrypted data packet. The incentive signal is preferably sent at least to the respective service device. Optionally, it is possible also to transmit the incentive signal to other computer-based entities, e.g. to the computer which is configured to administer the study.

The terms used in the context of embodiments of the invention will now be described in greater detail.

The medical data sets are patient-related data sets. These can be findings, diagnoses, symptoms of illnesses, history data, data on the application of drugs, medical measures applied and/or data concerning the identity of the patient (name, age, sex, etc.). Preferably, medical data sets which are relevant for the respective clinical trial are selected. If, for example, it is a pharmaceutical trial, then the medical data sets are usually selected as being trial-relevant and relating to the drugs administered. The trial-relevant medical data sets involve a selection of medical data sets. These data sets can exist in a variety of formats and comprise, for example, image data, text data and/or other data formats.

The purpose of the respective clinical trial is not important for carrying out embodiments of the present invention. The trial may be a pharmaceutical trial, a trial for monitoring patient compliance and/or general screening.

Normally, the medical data sets are recorded in the context of a medical intervention. For example, the data sets can be input in the context of the treatment of a patient by a physician. However, this is not necessarily required. It is therefore also possible for the medical data sets to be input following or before a medical examination.

Fundamentally, different involved persons can input the medical data sets. Firstly, it is possible for the patient himself to input the data and, secondly, the treating physician or a clinic assistant to input the necessary data sets via a user interface that has been provided. The data sets can also be read in by way of physical interfaces that have been provided.

Preferably, the reading-in of the medical data sets is carried out by a computer-based terminal device which is allocated to the relevant involved person. For example, the unit may be a (mobile or static) computer-based device associated with the patient (e.g. a smartphone) or a diagnostic computer associated with the physician. Herein, it is unimportant whether the physician is a registered medical practitioner or a member of a clinical association or a clinical institution.

The devices, in particular, the patient device and the physician device are each clearly allocated a device identification code. Furthermore, an association between a participating person (e.g. a physician and/or a patient) and the device is usually stored. In this way, an identification code can be unambiguously allocated to a patient or a medical service provider (e.g. physician).

The encrypted data packet is preferably generated locally on the terminal device and comprises the medical data set and the identification data set. Optionally, further data sets can also be included (e.g. the time of data acquisition, the type of data acquisition, whether first or repeated data acquisition, etc.). The encrypted data packet therefore contains at least anonymized data.

“At least anonymized data” in this context means that the data can no longer be allocated to a patient by the receiver (that is, in general, the central server). For this purpose, a code can be assigned to the data packet which enables the receiver to return an incentivization to the data transmitter (physician device and/or patient device). In other words, the transmitter of the data packet is to be addressable for the receiver (i.e. preferably for the central server) so that an incentive can be sent to the transmitter (typically the physician). Traceability of the transmitter should preferably be completely prevented on the central server, whereas the incentive can be allocated via the incentive signal. This can be implemented, for example, via de-identification methods, for example, a checksum method or parity bytes, etc.

According to one embodiment of the invention, the data packet also contains a code which ensures the addressability of the transmitter by the receiver without individualizing the transmitter at the receiver (server).

According to a further embodiment, the incentive signal can also comprise the same code and/or a second code. The second code can represent a receiver address.

It is fundamentally not possible, when a data packet is intercepted, to infer the identity of the physician and/or the patient, since the data sets transmitted are de-identified.

In one variant of an embodiment of the invention, it is essentially possible to encrypt the medical data sets separately. For this purpose, suitable symmetrical or asymmetrical encryption methods can be used, such as are known from the prior art (e.g. based on the RSA algorithm). For the encryption and decryption of the transmitted data sets, both the terminal devices (physician device and patient device) have available to them suitable encryption and decryption tools (e.g. for symmetrical or asymmetrical encryption).

The central server is configured as a central data service and engages in data exchange with the terminal devices. This data exchange is preferably carried out via the internet. The central server also engages in data exchange with other computer-based entities, including with a computer which is configured to administer the clinical trials. The central server can also engage in data exchange with computer-based entities of financial institutions. The central server is preferably configured to perform different computer-based processing steps automatically. For this purpose, the server comprises a processor or a group of processors and a memory store and engages in data exchange with a database. The server also comprises a decryption unit, a quality testing device and an incentive module.

The expression “decryption” relates to an automatically executed computer-implemented procedure which is carried out on the encrypted data packet received. The decryption has the result that the central server is able to collect and/or process the medical data sets. However, the medical data sets are preferably provided in an anonymized or de-identified form. It is thus also not possible on the central server to reconstruct the patient identity in relation to the respective medical data sets. This serves the purpose of data security so that the respective patient data cannot find its way into the hands of third parties. The central server can therefore only perform “blind” processing of the medical data. In particular, statistical methods can be applied (for example: “Which institution/which physician provides, at a configurable percentage rate, complete and/or consistent medical data sets?”, “Which patient does not provide the medical data sets on time?”, “Which physician within the hospital almost never provides clinical trial data?”, etc.). In an alternative embodiment, the process of decrypting relates to the complete or partial reconstruction of the original data sets (medical data sets and identification data sets) before the decryption.

According to a further aspect, in a simple embodiment, the encryption relates to a de-identification or anonymization and packing of the data sets and the decryption, as a process corresponding thereto, relates to the unpacking of the data sets received so that the associations necessary for the method can be arrived at and carried out. A complete reconstruction of the data set with the identity reconstruction of the transmitter is not necessary for this purpose.

The quality test is performed on the central server. The quality test can preferably be pre-configured in a preparation phase. It is possible here to stipulate which steps are to be performed by the test. Testing for the completeness of the data recording and for consistency is preferably carried out. Alternatively, further test steps (for semantic and/or syntactical correctness) can also be performed.

The “incentive attribute” is a parameterized data set which can comprise different parameters. The data set preferably comprises information on the size of a reward amount (incentive amount). The data set can also comprise a time point for the monetary reward. It is also possible to specify the recipients of the reward (e.g. in the form of the device addresses or the identification code of the terminal device). If no financial reward has been pre-configured, further reward measures, represented by way of incentive attributes, can be set. For example, it is possible to provide access to the trial data or other data sets by way of reward. Furthermore, points can be given out, granted to the respective participants on each successful quality test. It is also possible to provide further reward measures which are addressed via the incentive attribute.

The incentive signal comprises the incentive attribute and possibly also other data sets. It is possible to stipulate, for example, to which terminal device the inventive message is to be transmitted (the receiver for the incentive signal). Further information data can also be transmitted, for example, concerning the remaining period for the execution of the trial, statistical information regarding the reward (e.g. how often is the reward granted) or statistical information on the respective terminal devices (and thus also concerning the person involved, that is, the physician and/or the patient), etc.

The incentive signal is preferably also encrypted so that interception of the incentive signal does not enable reconstruction of the original data set. In this way, the security of the system can be advantageously increased.

The respective terminal device and/or the central server comprises device/module for encrypting and decrypting the data or for decrypting the encrypted data again. In an example embodiment of the invention, the method comprises an additional method step which is directed thereto that the respective involved persons (e.g. the medical service provider and/or the patient) have to register with the trial data quality testing system. It is then provided that the user connects into the system (e.g. with a known log-in procedure in which the user inputs a user ID and a password known only to the user).

Registration can be implemented, for example, on a web portal or as a web service and made available on the terminal device via the internet. The terminal devices can be static or mobile terminal devices (e.g. mobile telephone, smartphone, laptop computer, PDA (personal digital assistant)). Only once a registration procedure has been successfully completed can the quality testing method according to an embodiment of the invention be carried out. If a user cannot register successfully, a variety of different measures can be implemented. It is possible, for example, to offer to the user the ability to direct a registration inquiry to the central server. Furthermore, the user can also be excluded from the quality testing method. It is also possible to dispense with the registration procedure.

In an example embodiment, the computer network further comprises a chip card which includes an integrated circuit (ICC—integrated circuit card). The circuit typically comprises a memory store and a microprocessor and can be read by specific card reading devices. The chip card is associated with a patient in a unique manner. Thus, the physician and/or the patient can and must connect into the system via his chip card. Only after successful authentication is it possible to carry out the further method steps. Identification data relating to the user (e.g. physician or patient) and/or to the relation to the respective terminal device are stored on the memory chip card. However, in alternative embodiments, it is also possible to dispense with a chip card of this type and to provide the identification data in the form of biometric data or password data.

The identification data is preferably read in on a separate data channel like the medical data sets. The identification data preferably also originates from a different data source (e.g. from a chip card) from the medical data sets which usually are input manually. For this purpose, a web-based form is preferably provided. The form can be configured in a preparation phase. It can be specified, in particular, which data sets should be requested and recorded for the medical trial data. Apart from the medical data sets, patient-specific data sets (e.g. age, sex, address, etc.) can also be requested. One advantage is found, therefore, in the high flexibility, because the configuration of the data to be recorded can be configured in advance. Advantageously, the configuration of the data to be recorded can also be carried out online, that is, during operation of the quality monitoring.

In order to increase the security of the network, a specific communication protocol is implemented between the terminal devices involved and the central server. The communication protocol serves for the exchange of trial-relevant data. The protocol is based on the fact that the trial-relevant data is transmitted in a de-identified form between the terminal devices and the central server. This has the advantage that even if the data connection is corrupted (e.g. by interception of data packets between the terminal devices and the server) the respective data set cannot be fully reconstructed. In particular, if the data packet is intercepted, the identity of the patient and/or of the respective medical service provider (in relation to the medical data sets) cannot be discovered. The communication protocol can also be configured during the preparation phase. It is possible to specify which encryption method is to be used (e.g. in the simplest form, the use of a hash method, e.g. checksums, parity bytes, etc.).

The quality test comprises checking the completeness of the data sets entered. Moreover, time-limit observance can also be checked. It is also possible to carry out further checks of form and/or content, for example, semantic consistency in the data sets entered.

The acquisition of the medical data sets is preferably carried out using a pre-configurable form which is visualized on a user interface of the respective terminal device. The form can be provided as an HTML form on a web page. On the form, preferably the fields which must compulsorily be filled in are indicated. The later quality test then checks whether all the fields that have been indicated as compulsory have been filled in completely. The form can be called up on the terminal devices.

According to another advantageous embodiment, the central server keeps feedback data. The feedback data serves to provide feedback to the agency performing the clinical trial, concerning the performance of the institutions and persons involved. This provision of information can be carried out based on a statistical analysis of the data recorded. It is therefore possible to evaluate what percentage of successful quality tests has been achieved by which patient and/or which physician in what time period. Further criteria which are to be taken into account in the checking process can also be defined at this point, for example, the geographical regions of the institutions involved, the medical field, for example, sorted by diseases, punctuality of the data recording, etc. It can also be recorded, for example, how often a user has already passed a quality test and/or how often the user has failed. In the latter case, once a particular threshold value has been exceeded, the respective user can be excluded for further participation in clinical trials. Furthermore, pre-settings can be carried out in order to cover cases in which a user (physician and/or patient) has always been successful in quality tests in the past. Given a particular total of successful quality test results, an additional award in the form of an additional incentive can be granted to the respective user.

The encryption of the patient-related data can also be carried out using a key which is stored, based on a hyperlink, on the central server or a server of the data protection provider.

As stated above, the type of incentive arrangement is not limited. Apart from a monetary incentive, share options, travel miles from an airline or other transport provider or points at a store can also be provided.

According to a further embodiment, the present invention relates to a computer network system for quality testing clinical trial data that is input into a terminal device of a trial participant (medical service provider and/or patient).

Apart from the terminal devices, the computer network system also comprises identification devices. Preferably an identification device is provided for each patient and for each medical service provider, if both the patient and the medical service provider participate in the clinical trial. However, it is equally possible for only the physician or only the patient to participate in the clinical trial. In this event, only the person involved must identify or authenticate him or herself to the system. The computer network system comprises an encryption unit in order to transmit the medical data sets to be transmitted from the respective terminal device in anonymized form to the central server. The transmission is preferably carried out via the internet.

The central server comprises—as stated above—an encryption unit, a quality testing device and an incentive module. The central server also interacts with a database. The quality testing device serves to subject the medical data sets, which are to be unpacked on the server and are thus present in a non-encrypted form, to a quality test. The incentive module is only activated if the quality test could be successfully completed by the quality testing device. The incentive module serves to carry out a database access in order to detect an incentive attribute. The incentive attribute comprises a reward signal. A recipient for the reward signal can also be identified. The incentive attribute is possibly packed together with other data into an incentive signal. The incentive signal is then sent as the response to the transmitted encrypted data packet at least to each transmitter of a data packet, that is to the respective terminal devices. The incentive signal can also be encrypted, compressed and/or can comprise further databases (in particular addresses of transmitters and/or receivers).

The server comprises an analysis module for carrying out the clinical trial. Alternatively, the server is involved in a data exchange with the administrating computer of one or more clinical trials. The trials can also be configured to record statistical data and to calculate, in particular, a grouping and characterization of disease data and/or disease progress. Furthermore, pattern recognition procedures can be performed on the assembled medical data sets. This can preferably be performed without identifying the respective patient. Furthermore, relationships from the information technology standpoint can also be generated between the collected data sets, comprising: analogous relations, parent-child relations in a hierarchy, etc. Reference data can also be generated in order finally to improve the quality of the diagnosis.

A further solution to the problem resides in a computer program product according to the accompanying claims.

The method, in at least one embodiment, is computer implemented and preferably runs entirely automatically, which means until input of the trial data without any interaction with a user. The method can be partially or entirely software-based. It is also possible to embed or integrate the method or the system as an embedded system into the respective terminal devices and/or in a server or in an item of medical technology system and/or in a control computer (e.g. in the context of the central server). The method serves for the storage, processing and passing on of prepared data (in the form of incentive signals and a quality test signal) using computer-based technical equipment (network) or other entities. The input variables for administration of the clinical trial are, according to the invention, addressed and processed differently (taking account of a quality test) and are therefore stored modified. The method therefore also takes account of the circumstances of the data processing system in that, for the operation of the device, the components and the programs thereof are tested.

In general, the method of at least one embodiment is computer-implemented. It may be that particular method sections are part of a microprocessor solution and are therefore hard-wired, whereas other sections of the method are configured as software. In this event, only individual sections or parts of the method are implemented in software. In general, all or selected sections of the method are encoded in binary form or are present in digital form. All or individual sections of the method can be interpreted as source code, as ready compiled code (machine code) or as interpreted code (e.g. in the interpreter languages Python, PHP, Ruby) or by way of an interpreter (e.g. a Jit compiler).

As far as the execution of at least one embodiment of the inventive method and of the products also claimed are concerned, it is unimportant in which programming language (e.g. (C++, Java, Perl, PHP, etc.) the software exists. What is important is that the software is directly linked into the technical device as part of a technical system and there serves for controlling the installation of different versions. The parts of at least one embodiment of the inventive method which are implemented as software can be part of an “embedded system” which is embedded in the surrounding medical-technical system and interacts therewith.

A solution, of at least one embodiment, to the problem is described below in relation to the claimed method. The features, advantages or alternative embodiments mentioned are also to be applied equally to the other claimed subject matter and vice versa. In other words, the present claims (which are directed, for example, to the system) can also be developed with the features disclosed or claimed with regard to the method. The corresponding functional features of the method are configured with suitable modules as contained herein, in particular microprocessor modules.

The inventive embodiments of the method as disclosed herein can also be configured as a computer program product with a computer program, the computer being caused to carry out at least one embodiment of the inventive method described above when the computer program is executed on the computer or on a processor of the computer.

An alternative solution to the problem lies in a computer program with computer program code for carrying out all the method steps of an embodiment of the method claimed or described above, when the computer program is executed on the computer. The computer program can also be stored on a machine-readable storage medium.

An alternative solution to the problem provides for a storage medium which is intended for storing an embodiment of the computer-implemented method described above and is readable by a computer.

It is also within the scope of the invention that not all the steps of the method necessarily have to be executed on the same computer unit (terminal device, central server), but can also be carried out on different computer units. The sequence of method steps can also, if required, be varied or enhanced with further steps.

It is also possible for individual portions of the method described above to be implemented in a commercially saleable unit and for the remaining components to be implemented in another saleable unit as what is known as a distributed system.

The invention will now be described in greater detail making reference to the two figures and the example embodiments illustrated therein.

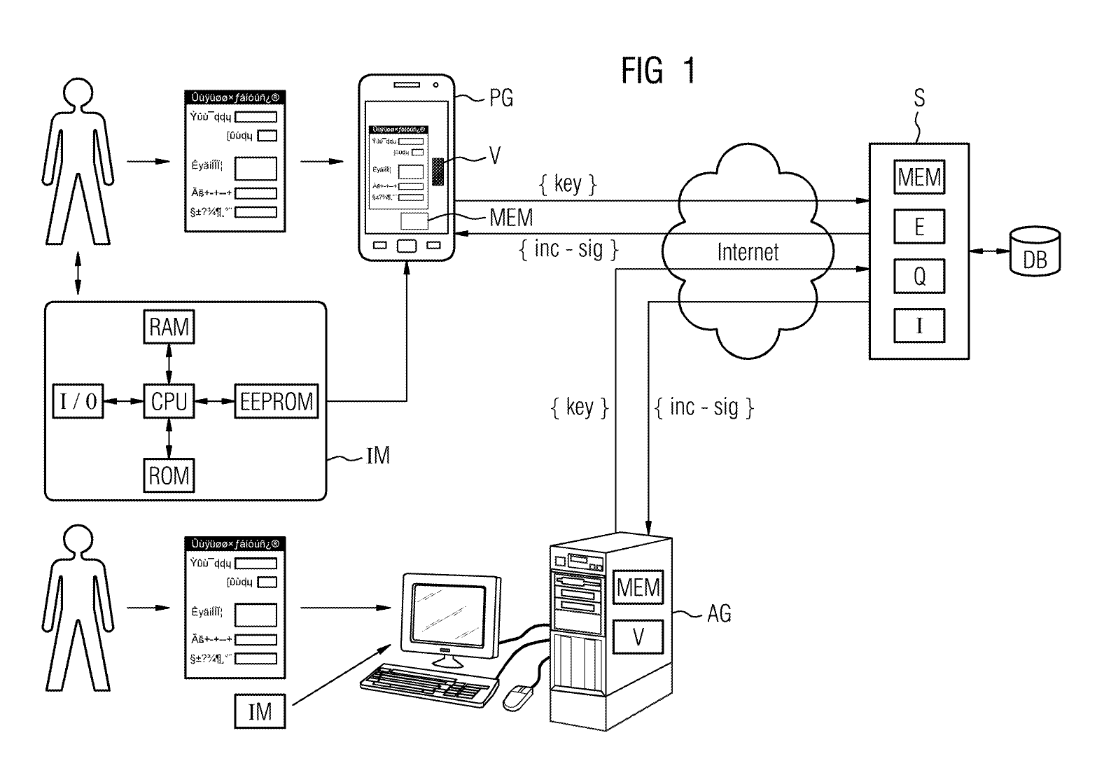

As FIG. 1 shows, the invention serves for quality testing clinical trial data. For this purpose, a central server S is provided which interacts with a plurality of computer-based devices PG, AG. In particular, a patient, shown at top left in FIG. 1, can input data into the patient device PG by way of a form. Furthermore, a physician, shown at bottom left in FIG. 1, can also input data by way of a form relating to the trial via a computer terminal device AG allocated to the physician. The computer terminal device can be, for example, a computer-based diagnostics station. Alternatively, the device can be a mobile terminal device AG.

In order to simplify inputting the trial data, a form is provided according to the invention which can be downloaded via the internet for example, in order to be displayed in a user interface on the respective terminal device PG, AG.

An advantageous aspect of the invention relates thereto that the form can be configured in a preparation phase. It is also possible to alter the form during operation and, for example, by inclusion of new fields or by modifying or deleting old input fields, to modify the form.

An identification module IM is also provided, by which the respective user (e.g. physician or patient) can carry out authorization or authentication on the server. As indicated in FIG. 1, the identification module can be, for example, a memory chip card. The card comprises an input and output device I/O, a processing unit CPU, memory components such as a Random Access Memory RAM, read only memory ROM and an EEPROM. Depending on the embodiment, the identification data stored on the chip card relating to the patient can be read into different devices of the computer network system. FIG. 1 shows that the identification data relating to the patient which is stored on the chip card IM is read in by the terminal device PG. Alternatively, however, the data can be read in on another computer-based entity connected to the computer network system. It is also possible for the chip card IM to be read in onto the central server S.

The physician declaring himself prepared to take part in the clinical trial and inputting clinical trial data into the system must preferably also identify himself with an identification device IM. The identification device does not necessarily have to match the identification measures for the patient. For example, it is possible for the physician to authenticate himself by logging in with a password on the system.

In order to increase the security of the system, patient-related and/or trial-related data is not transmitted in plain text to the server S, but rather in an encrypted form. Therefore, in an example embodiment, an encryption module V which serves to generate a data packet, key, is implemented on the terminal device. The data packet can be transmitted from the respective terminal device PG, AG to the server S.

The terminal device PG, AG advantageously also comprises a memory store MEM.

The encrypted data packet, key, comprises the clinical trial data input, as well as identification data. The identification data can relate to the respective input device PG, AG and/or to the user (e.g. physician or patient). Naturally it is also possible for other involved persons (e.g. medical personnel or other medical service providers) to input clinical trial data via a connected terminal device.

The central server S comprises a memory store MEM, a decrypting unit E, quality testing device Q and an incentive module I. The server S is connected for data exchange with a database DB. Alternatively, the database DB can also be integrated into the server S. It follows directly, for a person skilled in the art, that the server S can also be implemented as a server network or as a cloud system. Furthermore, the services provided (e.g. a web-based form) can also be based on an SOA implementation.

The decryption unit E serves to receive and decrypt the data sets, key, encrypted by the encryption unit V.

The quality testing device Q serves to subject the decrypted medical data sets to a quality test. Advantageously, the quality test can be configured. In other words, the parameters of the test can be kept flexible. Preferably, the medical data sets received are tested for completeness. In this process, the expression “completeness” relates both to complete input within a data field of the form (for example, the full name and not just the first name) and also the filling-in of all the compulsory fields of the form. It is therefore not sufficient for the quality requirements if only part of the required form fields are filled in. In addition, the input clinical trial data is tested for consistency. Advantageous developments also provide for time period monitoring which checks whether the clinical trial data has been input in a timely manner. Further checking measures can also be instigated.

According to an embodiment of the invention, it is provided that the further steps are performed only if the checks are positive (thus if the relevant medical data set has passed the quality test). In that case, access to the database DB is instigated in order to read out incentive-related data sets. In particular, for the relevant terminal device PG, AG, an incentive attribute allocated thereto is to be recorded. The incentive attribute comprises signals and data sets in order to reward the respective transmitter of the clinical trial data. The reward is not restricted to a financial reward, but also comprises other reward forms, for example, the collecting of points or the booking of options and/or the crediting of units. The incentive attribute is not transmitted directly to the respective transmitter of the clinical data sets, nor, matched thereto, is the incentive attribute transmitted to the receiver, but rather is encrypted in advance by the central server S so that, if the data connection between the terminal device PG, AG and the server S is intercepted, no data misuse can be perpetrated. For this purpose, the incentive module I generates an incentive signal inc-sig which comprises the incentive attribute. In a development of an embodiment of the invention, the incentive signal inc-sig can also specify the address of the recipient of the incentive signal (e.g. an IP address) or further data sets. The incentive signal inc-sig is transmitted to the respective trial participant to whom the reward is to be granted for fulfilling the quality requirements. In FIG. 1, this is both the patient device PG and the physician device AG.

Naturally, it also lies within the scope of embodiments of the invention that the incentive signal inc-sig is also passed to other computer-based entities.

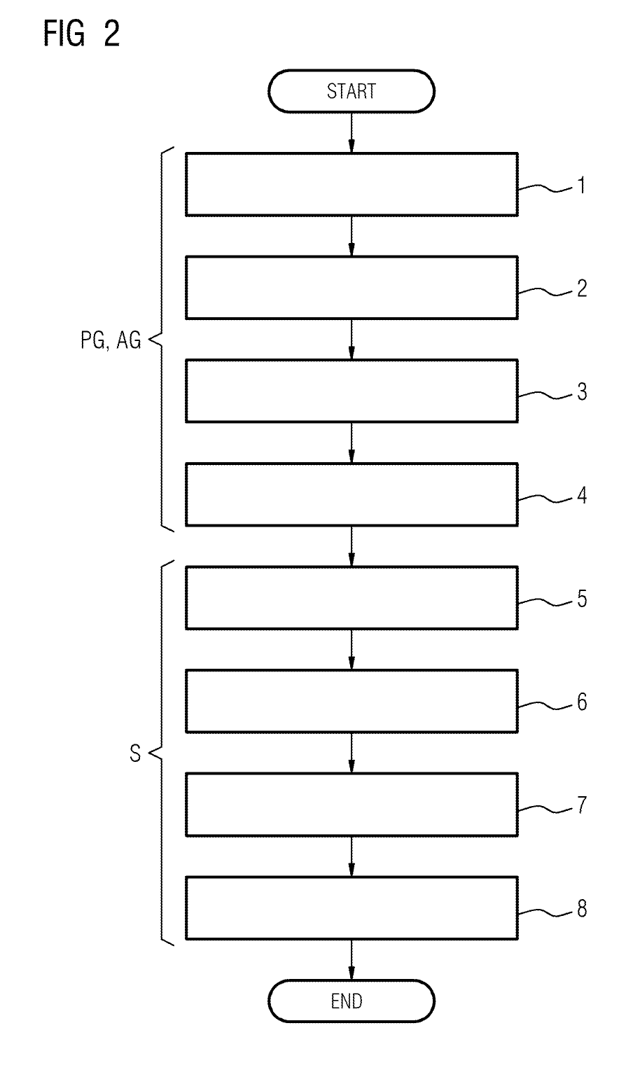

A typical sequence according to an example embodiment of the invention will now be described in greater detail, making reference to FIG. 2.

Following the Start in step 1, patient-specific, service provider-specific and/or terminal device-specific identification data of the trial participants is recorded.

In step 1, medical data sets of relevance to the trial in question are read in, wherein the medical data sets can be input via a pre-configurable web-callable form by the patient and/or the physician.

In step 3, an encrypted data packet, key, is generated from the medical data sets and the identification data and is transmitted, in step 4, to the central server.

Following reception of the encrypted data packet, key, in step 5, the received data is decrypted on the central server S.

Thereafter, in step 6, the pre-configurable quality test is carried out on the decrypted medical data sets. It is checked here, inter alia, whether the clinical trial data has been input in a timely manner, completely and/or consistently to the terminal device PG, AG. Only if the test result is a success is an incentive attribute allocated to the relevant transmitter. In the event of faulty, incomplete or non-timely transmission of the data, in a development of the invention, it can be provided that the user in question is informed thereof via the terminal device PG, AG of the user with a suitable message. Furthermore, the test result can also be notified to the agency performing the clinical trial.

The recording of the incentive attribute is carried out in step 7 through access to the database DB. Preferably, access takes place via the medial data sets. In the database DB, relations between incentive attributes and different data sets are stored. These different data sets comprise the type (e.g. the scope) of the trial data being requested in order to be able to indicate that very complex data recordings also receive a higher reward, whereas only short recording forms entail a smaller reward. Furthermore, differences between the respective terminal devices and/or users can also be taken into account herein. Thus it is possible to stipulate that a physician who has logged in on a physician device AG, receives a higher reward than a patient who has logged in on a patient device PG. Furthermore, it can be stipulated in the database DB that different incentive attributes (that is, rewards) are granted for the different trials. In a less intense and more economical trial, for example, smaller reward rates can be defined than for a highly demanding, costly and complex trial.

Preferably, the incentive attribute is not directly transmitted unchanged to the device PG, AG of the reward recipient, so that on receipt of the message, it is not possible to conclude which user receives which reward. Therefore, the incentive module I preferably also comprises an encryption unit in order to generate an incentive signal inc-sig from the incentive attribute.

In step 8, the incentive signal inc-sig which has been generated and which comprises the incentive attribute and possibly also further data, is then transmitted as a response to the transmitted data packet, key, at least to the respective reward recipient AG, PG.

If, as stated above, the incentive signal inc-sig also comprises the address of the reward recipient, then in an advantageous development, a test can be carried out on the relevant terminal device PG, AG as to whether the transmission address of the data packet, key, actually matches the reception address of the incentive signal inc-sig. Only if there is a match is the incentive activated or carried out. In the event of an error, an error message can be output to the respective user interfaces.

In FIG. 2, it is shown by the curved brackets on the left side and by the labeling thereof that steps 1 to 4 inclusive are carried out on the terminal devices PG, AG, whereas steps 5 to 8, inclusive, are carried out on the server S.

An aspect of an embodiment of the invention lies therein that the server S can also test a plurality of clinical trials in parallel for quality. This results in the advantage that uniform quality criteria can be used for different trials, which can all be administered together on the server S.

Finally, it should be noted that the above description of the invention with the example embodiments should not be seen as in any way restrictive with regard to a particular physical realization of the invention. It is, in particular, obvious for a person skilled in the art that the invention is not restricted to particular types of clinical trial data, but can also be used for other data recordings. It is also not absolutely necessary for particular monitor technologies to be used (monitors and conventional input devices or touch-sensitive screens). Furthermore, using the form, data which is not present as string data or text data, such as medical image data (of the patient), can be included. In addition to a DICOM format, other data formats can also be processed. For example, proprietary protocols for image acquisition and storage can also be used. Furthermore, embodiments of the invention can be implemented partially or entirely in software and/or hardware. Furthermore, embodiments of the inventive method or the network system can also be realized distributed over a plurality of physical products comprising computer program products.

What is claimed is:

1. A computer network system for exchanging medical data sets for quality testing of the medical data sets when clinical trials are performed, comprising:
a terminal device, allocated to at least one of a medical service provider and a patient and by which the at least one service provider and patient is configured to at least one of input and receive trial-relevant medical data sets according to a pre-configurable data protocol for data exchange with a central server;
identification devices, each allocated to a at least one of a respective patient and terminal device, each configured to serve to authenticate an identity of the respective patient, service provider and/or terminal device user and to provide respective patient-specific, service provider-specific and/or terminal device-specific identification data; and
an encryption unit, configured to generate an encrypted data packet at least from the trial-relevant medical data sets recorded on the terminal device and from the identification data, and to transmit the encrypted data packet via the network to the central server, the central server comprising:
a decryption unit, configured to receive and decrypt the data sets encrypted by the encryption unit,
a quality testing device, configured to subject the decrypted medical data sets to a pre-configurable quality test,
a database, configured to store the incentive-related data sets, and
an incentive module, only activated if the quality test of the quality testing device was successful, configured to access the database in order to record an incentive attribute and configured to generate an incentive signal with the incentive attribute and configured to transmit the incentive signal, as a response to the transmitted encrypted data packets, at least to the respective terminal device.

2. A method for exchanging medical data sets for quality testing of the data sets when clinical trials are performed, comprising:
recording at least one of patient-specific, service provider-specific and terminal device-specific identification data;
reading in trial-relevant medical data sets, wherein the medical data sets are inputtable by at least one of the patient, the service provider and an involved person;
generating an encrypted data packet with the medical data sets and the identification data and transmitting the encrypted data packet to a central server;
receiving the encrypted data packet on the central server and decrypting the encrypted data packet;
carrying out a quality test with the decrypted medical data sets; and
in the event of the quality test being successful:
accessing a database to acquire an incentive attribute, and
sending an incentive signal with the incentive attribute, as a response to the transmitted, encrypted data packet, to the respective terminal device.

3. The method of claim 2, wherein the incentive attribute includes at least one of computer-readable data sets and instructions which include at least one of a financial remuneration, access to trial data, a credit note, the collection of points and other actions.

4. The method of claim 2, further comprising:
registering, as an initial step, at least one of the patient, the service provider and the terminal device at the central server, wherein all the subsequent method steps are only carried out after the registration is successful.

5. The method of claim 2, wherein the identification data includes at least one of biometric data, a password and an identification code, stored on a chip card or on another mobile data carrier.

6. The method of claim 2, wherein the quality test comprises at least one of checking for completeness, timeliness and consistency of at least one of form and semantics.

7. The method of claim 2, wherein a communications protocol for data exchange of trial-relevant data is provided between the terminal device and the central server, based on an anonymized transmission of data such that, even in the event that a data packet is intercepted, it is not possible to discover at least one of the patient and the service provider.

8. The method of claim 2, wherein the central server stores feedback data which indicates which terminal device has successfully passed a quality test, and wherein the feedback data comprises information concerning at least one of frequency, time frame and other pre-configurable further criteria with which each respective terminal device has successfully passed the quality test.

9. The method of claim 2, wherein the medical data is recorded by way of a pre-configurable form which is shown on a user interface of the terminal device.

10. A computer program product, loadable or loaded into a memory store of a computer, including commands which are readable by the computer for carrying out the method of claim 1 when the commands are carried out on the computer.

11. A non-transitory computer readable, including commands which are readable by the computer for carrying out the method of claim 1 when the commands are executed on the computer.

12. The method of claim 3, further comprising:
registering, as an initial step, at least one of the patient, the service provider and the terminal device at the central server, wherein all the subsequent method steps are only carried out after the registration is successful.

13. The method of claim 3, wherein the identification data includes at least one of biometric data, a password and an identification code, stored on a chip card or on another mobile data carrier.

14. The method of claim 3, wherein the quality test comprises at least one of checking for completeness, timeliness and consistency of at least one of form and semantics.

15. The method of claim 3, wherein a communications protocol for data exchange of trial-relevant data is provided between the terminal device and the central server, based on an anonymized transmission of data such that, even in the event that a data packet is intercepted, it is not possible to discover at least one of the patient and the service provider.

16. The method of claim 3, wherein the central server stores feedback data which indicates which terminal device has successfully passed a quality test, and wherein the feedback data comprises information concerning at least one of frequency, time frame and other pre-configurable further criteria with which each respective terminal device has successfully passed the quality test.

17. The method of claim 3, wherein the medical data is recorded by way of a pre-configurable form which is shown on a user interface of the terminal device.
